(19) United States
(12) Patent Application Publication
(10) Pub. No.: US 2026/0196561 A1
(43) Pub. Date: Jul. 9, 2026

(54) STERICALLY HINDERED ELECTROLYTES FOR LITHIUM SULFUR BATTERIES

(71) Applicant: UCHICAGO ARGONNE, LLC, Chicago, IL (US)

(72) Inventors: Xianyang WU, Westmont, IL (US); Chi Cheung SU, Westmont, IL (US); Khalil AMINE, Oakbrook, IL (US)

(73) Assignee: UCHICAGO ARGONNE, LLC, Chicago, IL (US)

(21) Appl. No.: 19/434,641

(22) Filed: Dec. 29, 2025

Related U.S. Application Data
(60) Provisional application No. 63/742,321, filed on Jan. 6, 2025.

(51) Int. Cl. H01M 10/0567; H01M 4/02; H01M 4/36; H01M 4/38; H01M 4/58; H01M 4/587; H01M 10/052; H01M 10/0568; H01M 10/0569; H01M 10/42

(52) U.S. Cl. CPC H01M 10/0567; H01M 4/366; H01M 4/382; H01M 4/5815; H01M 4/587; H01M 10/052; H01M 10/0568; H01M 10/0569; H01M 10/4235; H01M 2004/021; H01M 2004/028; H01M 2300/0028

(57) ABSTRACT

A lithium-sulfur battery includes a cathode including surface-confined sulfur; an anode that includes lithium metal; and an electrolyte that includes a sterically hindered carbonyl solvent and/or a fluorinated sulfone; and a lithium salt.

### CROSS-REFERENCE TO RELATED APPLICATIONS

This application claims priority to and the benefit of U.S. Provisional Patent Application No. 63/742,321, filed on Jan. 6, 2025, which is incorporated herein by reference in its entirety.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to electrolytes for rechargeable electrochemical cells, and more specifically is related to electrolyte additives for lithium-sulfur batteries.

### SUMMARY

In one aspect, an electrochemical cell includes a cathode comprising surface-confined sulfur; an anode including lithium metal; and an electrolyte including a sterically hindered carbonyl solvent; and a lithium salt. In some embodiments, the sterically hindered carbonyl solvent includes 3-methyldihydrofuran-2 (3H)-one). In other embodiments, the sterically hindered carbonyl solvent may include 3,3-dimethyldihydrofuran-2 (3H)-one. In some embodiments, the surface-confined sulfur is a sulfurized calcined polyacrylonitrile.

In another aspect, an electrolyte for a lithium-sulfur electrochemical cell includes a sterically hindered carbonyl solvent and a lithium salt. In some embodiments, the sterically hindered carbonyl solvent includes 3-methyldihydrofuran-2 (3H)-one). In other embodiments, the sterically hindered carbonyl solvent may include 3,3-dimethyldihydrofuran-2 (3H)-one.

In a further aspect, an electrochemical cell includes a cathode including a surface-confined sulfur, an anode including lithium metal, and an electrolyte including a fluorinated sulfone, and a lithium salt. In some embodiments, the fluorinated sulfone is a compound of formula:

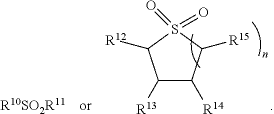

In the above formulae, R¹⁰ and R¹¹ are each individually alkyl, where at least one of R¹⁰ and R¹¹ is at least partially fluorinated; R¹², R¹³, R¹⁴, and R¹⁵ are each individually alkyl, cycloalkyl, aryl, heteroaryl, or any two may join together to form a fused ring, where at least one of R¹³, R¹⁴, R¹⁵, and R¹⁶ is at least partially fluorinated; and n is 1 or 2; and where any alkyl, cycloalkyl, aryl, or heteroaryl group optionally includes O, N, or S atoms.

### BRIEF DESCRIPTION OF THE DRAWINGS

FIG. 1A is a graph of voltage profile (1^{st} to 3^{rd} cycle), and FIG. 1B is graph of cycling performance of Li∥SPAN (“SPAN” is an abbreviation for sulfurized polyacrylonitrile) cells in an electrolyte of 1M LiTFSI DOL/DME 1/1 on a volume basis, according to the examples.

FIG. 2A is a graph of cycling performance and FIG. 2B is a graph of coulombic efficiency (CE) of Li∥SPAN cells using in an electrolyte of 1M LiFSI in FEC/MA 1/1 on a volume basis, according to the examples.

FIG. 3A is a graph of cycling performance and FIG. 3B is a graph of coulombic efficiency of Li∥SPAN cells using in an electrolyte of 1.0M LiFSI FEC/MA 1/1 (volume ratio), 1.0M LiFSI FEC/EA 1/1 (volume ratio), and 1.0M LiFSI FEC/MTMA 1/1 (volume ratio), according to the examples.

FIGS. 4A-4D are graphs of cycling performance of Li∥SPAN cells using (FIG. 4A) 1.0M LiFSI FEC/GBL/TTE 2/1/1 (volume ratio), (FIG. 4B) 1.0M LiFSI FEC/GVL/TTE 2/1/1 (volume ratio), (FIG. 4C) 1.0M LiFSI FEC/MBL/TTE 2/1/1 (volume ratio), and (FIG. 4D) 1.0M LiFSI FEC/DMBL/TTE 2/1/1 (volume ratio) electrolytes, according to the examples.

FIG. 5 is a voltage profile of Li∥SPAN cell employing 1M LiFSI FEC/EMS electrolyte with conventional separator, and showing inferior wetting of the separator according to the examples.

FIGS. 6A and 6B are voltage profiles and cycling performance, respectively of a Li∥SPAN cell using 100 μL 1M LiFSI in FEC/EMS electrolyte with glass fiber separator, according to the examples.

FIGS. 7A and 7B are graphs showing (a) voltage profiles and (b) cycling performance, respectively for a Li∥SPAN cell using 1M LiFSI in FEC/FMMS electrolyte, according to the examples.

FIGS. 8A and 8B are graphs showing (a) voltage profiles and (b) cycling performance, respectively, for a Li∥C—S cell using 1M LiFSI in FEC/FMMS electrolyte, according to the examples.

FIG. 9 is a graph of cycling performance for a Li∥SPAN cell using 1M LiFSI in FEC/EMS and 1M LiFSI in FEC/FMMS electrolytes with different separators, according to the examples.

FIGS. 10A and 10B are graphs of (a) voltage profiles and (b) cycling performance, respectively, for a Li∥SPAN cell using LiFSI:FMMS 1:4 electrolyte, according to the examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In contrast to lithium-ion batteries that typically use carbonyl-based materials, such as ethylene carbonate and dimethyl carbonate, as electrolyte solvents, lithium-sulfur batteries often employ ether-based solvents. This is because lithium polysulfide species (LiPSs) that form in lithium sulfur batteries tend to rapidly react with the carbonyl group, leading to cell failure.

Accordingly, in one aspect, the present disclosure is directed to electrolytes for lithium-sulfur batteries that include sterically hindered carbonyl-based solvents to facilitate stability and high rate cycling, where the cathode includes physically confined sulfur. Illustrative cathodes include those with nano-confined sulfur and/or sulfurized calcined polyacrylonitrile (SPAN). Physically confined sulfur (PYS) cathodes confine the sulfur on a scaffold, thereby limiting the contact between LiPSs and the solvents having a carbonyl group. Often, Li∥PYS cells using regular esters, such as methyl acetate, fail to cycle properly. To address this, highly sterically hindered solvents are introduced, effectively blocking LiPSs from reacting with the carbonyl group. Nano-confined sulfur cathodes may be formed by melting and/or subliming sulfur and infusing it into porous carbon materials. Infusing the sulfur into the carbon may be conducted at a temperature of about 100° C. to 600° C. (e.g., 200° C. to 500° C., 300° C. to 400° C., or 350° C.) and at a pressure of about 10 mTorr to about 100 Torr. The porous carbon materials may include microporous, nanoporous, and/or ultramicroporous materials. Carbon materials may be formed by carbonizing and/or calcining polymers via thermal treatment of the polymer. Electrodes synthesized using this method may exhibit a specific capacity of about 1200 mAh/g.

Illustrative, highly hindered carbonyl solvents include, but are not limited to, those such as methyl butyrolactone (“MBL” or alternatively 3-methyldihydrofuran-2 (3H)-one), dimethyl butyrolactone (“DMBL” or alternatively 3,3-dimethyldihydrofuran-2 (3H)-one), and methyl pivalate (“MTMA” or alternatively methyl trimethylacetate. The beneficial effects of highly sterically hindered carbonyl solvents were further confirmed by comparing the cycling performance of Li∥SPAN cells using different γ-lactone solvents with varying susceptibility to nucleophilic attack. In the case of γ-butyrolactone (GBL) and γ-valerolactone (GVL), the absence of a α-methyl group adjacent to the carbonyl carbon exposed the carbonyl group susceptible to nucleophilic attack.

The electrolyte may further include a charge carrier salt. The charge carrier salt may include a lithium salt. The lithium salt may include lithium trifluoromethanesulfonamide (LiTFSI), lithium bis(fluorosulfonyl)imide (LiFSI), lithium alkyl fluorophosphates; lithium alkyl fluoroborates; lithium 4,5-dicyano-2-(trifluoromethyl) imidazole; lithium 4,5-dicyano-2-methylimidazole; trilithium 2,2′,2″-tris(trifluoromethyl)benzotris (imidazolate); LiN(CN)₂; Li(CF₃CO₂); Li(C₂F₅CO₂); LiCF₃SO₃; LiCH₃SO₃; LiN(SO₂CF₃)₂; LiN(SO₂F)₂; LiC(CF₃SO₂)₃; LiN(SO₂C₂F₅)₂; LiClO₄; LiBF₄; LiAsF₆; LiPF₆; LiBF₂ (C₂O₄), LiB(C₂O₄)₂; LiPF₂ (C₂O₄)₂; LiPF₄ (C₂O₄); LiAsF₆; LiN(SO₂CF₃)₂; LiN(SO₂F)₂; Li₂(B₁₂X₁₂₋ₚHₚ); Li₂(B₁₀X_{10-p′}H_{p′}); or a mixture of any two or more thereof, wherein X is independently at each occurrence a halogen, p is 0, 1, 2, 3, 4, 5, 6, 7, 8, 9, 10, 11, or 12, and p′ is 0, 1, 2, 3, 4, 5, 6, 7, 8, 9, or 10. The charge carrier salt may be present in the electrolyte at any amount including from about 0.1 M to 3 M, and any value there between. This may include a concentration from about 0.5 M to about 2 M. For example, the charge carrier salt may be 1.0 M LiFSI.

The electrolyte may further include one or more shuttle inhibitor additives. The shuttle inhibitor additives may include LiClO₄ and/or other salts with ionic N—O bonds. Illustrative shuttle inhibitors include, but are not limited to, lithium nitrate, lithium nitrite, potassium nitrate, potassium nitrite, cesium nitrate, cesium nitrite, barium nitrate, barium nitrite, ammonium nitrate, ammonium nitrite, dialkyl imidazolium nitrates, guanidine nitrate, ethyl nitrite, propyl nitrite, butyl nitrite, pentyl nitrite octyl nitrite, nitromethane, nitropropane, nitrobutanes, nitrobenzene, dinitrobenzene, nitrotoluene, dinitrotoluene, nitropyridine, dinitropyridine, pyridine N-oxide, alkylpyridine N-oxides, and tetramethyl piperidine N-oxyl (TEMPO). The concentration of the shuttle inhibitor in the electrolyte is from about 0.01 weight percent (wt. %) to about 5 wt. %. In some embodiments, the concentration of the shuttle inhibitor in the electrolyte is from about 0.1 wt. % to about 3 wt. %. In some embodiments, the concentration is from about 1.5 wt. % to about 2.5 wt. %, such as about 2.0 wt. %. The shuttle inhibitors assist in the formation of a dense protective passive film on the surface of the anode which benefits the transfer of lithium ions and plays a role in preventing the reaction between polysulfides and the lithium anode.

In addition to the highly hindered carbonyl solvents, additional solvents may be added to the electrolyte. Such other solvents may include, but are not limited to, acetals, ketals, sulfones, acyclic ethers, cyclic ethers, glymes, polyethers, dioxolanes, silanes, siloxanes, ionic liquids, substituted forms of the foregoing, and blends or mixtures of any two or more such solvents. Examples of acyclic ethers that may be used include, but are not limited to, diethyl ether, dipropyl ether, dibutyl ether, dimethoxymethane, trimethoxymethane, dimethoxyethane (DME), diethoxyethane, 1,2-dimethoxypropane, and 1,3-dimethoxypropane. Examples of cyclic ethers that may be used include, but are not limited to, fluoroethylene carbonate (FEC), tetrahydrofuran (THF), tetrahydropyran, 2-methyltetrahydrofuran, 1,4-dioxane, 1,3-dioxolane (DOL), and trioxane. The cyclic ethers include non-polar fluorinated ether solvents, including, but not limited to, 1,1,2,2-tetrafluoroethyl-2,2,3,3-tetrafluoropropyl ether (TTE); 1,1,2,2-tetrafluoroethyl-2,2,3,3,3-pentafluoropropyl ether; 2,2,2-trisfluoroethyl-1,1,2,3,3,3-hexafluoropropyl ether; ethyl-1,1,2,3,3,3-hexafluoropropyl ether; difluoromethyl-2,2,3,3,3-pentafluoropropyl ether; difluoromethyl-2,2,3,3-tetrafluoropropyl ether; 2-fluoro-1,3-dioxolane; 2,2-difluoro-1,3-dioxolane; 2-trifluoromethyl-1,3-dioxolane; 2,2-bis(trifluoromethyl)-1,3-dioxolane; 4-fluoro-1,3-dioxolane; or 4,5-difluoro-1,3-dioxolane. Examples of polyethers that may be used include, but are not limited to, diethylene glylcol dimethyl ether (diglyme), triethylene glycol dimethyl ether (triglyme), tetraethylene glycol dimethyl ether (TEGDME), higher glymes, ethylene glycol divinylether, diethylene glycol divinylether, triethylene glycol divinylether, dipropylene glycol dimethylether, and butylene glycol ethers. Examples of sulfones that may be used include, but are not limited to, dimethylsulfoxide, sulfolane, 3-methyl sulfolane, and 3-sulfolene. Other electrolyte solvents that may be used include, but are not limited to, oligo (ethylene glycol)-substituted siloxanes, oligo (ethylene glycol)-substituted silanes, and ionic liquids. Ratios of highly hindered carbonyl solvents to other solvents in the electrolyte may be about 1:10 to about 10:1 (e.g., 1:5, 1:2, 1:1, 2:1, or 5:1). For example, the additional solvent may include a cyclic ether, which may include fluoroethylene carbonate (FEC), 1,1,2,2-tetrafluoroethyl-2,2,3,3-tetrafluoropropyl ether (TTE), or a combination thereof. For example, the ratio of highly hindered carbonyl solvents to additional solvent may be 1:1.

The cathode of the Li—S battery is a sulfur-based electrode that includes sulfur and may also include metal sulfide and/or conductive carbon. The sulfur may be elemental and provided as such. The sulfur may be combined with active metal sulfide materials. The metal sulfide materials may include Mo₆S₈. Examples of conductive carbons include synthetic graphite, natural graphite, amorphous carbon, hard carbon, soft carbon, acetylene black, mesocarbon microbeads (MCMB), carbon black, Ketjen® black, carbon Super P, mesoporous carbon, porous carbon matrix, carbon nanotube, carbon nanofiber, graphene, ultramicroporous carbon, and mixtures of two or more thereof. The conductive carbon is preferably porous allowing for sequestration or entrapment of the sulfur within the conductive carbon, thereby rendering the sulfur confined to the cathode.

The cathode may be prepared by mixing sulfur with a conductive carbon material and a binding agent in the presence of a solvent to form a slurry. Illustrative binders include, but are not limited to, gelatine, polytetrafluoroethylene (PTFE), polyvinylidene fluoride (PVDF), polyethylenetetrafluoroethylene (ETFE), polyvinyl alcohol (PVA), polyethylene, polystyrene, polyethylene oxide, polyacrylonitrile, polyimide, polyamide, styrene butadiene rubber (SBR), carboxy methyl cellulose (CMC), alginate, gelatin, a copolymer of any two or more such polymers, or a blend of any two or more such polymers. The solvent may be N-methylpyrrolidone, acetone, water, or the like. The cathode may be prepared by coating and drying the mixture of the sulfur, carbon material, and binding agent directly on a current collector, or by casting the mixture on a separate support to form a film and then laminating the film on a current collector.

Illustrative anode materials include metallic lithium and carbon materials including, but not limited to, synthetic graphite, natural graphite, amorphous carbon, hard carbon, soft carbon, mesocarbon microbeads (MCMB), or a combination thereof. The anode active material may be a metallic lithium foil alone, metallic lithium mixed with an active carbon material, or metallic lithium intercalated within an active carbon material, where the active carbon material may be, but is not limited to, synthetic graphite, natural graphite, amorphous carbon, hard carbon, soft carbon, mesocarbon microbeads (MCMB).

According to some embodiments, the current collector may include copper, stainless steel, titanium, tantalum, platinum, gold, aluminum, nickel, cobalt nickel alloy, highly alloyed ferritic stainless steel containing molybdenum and chromium; or nickel-, chromium-, molybdenum-containing alloys, and carbon-coated versions of any one or more thereof. The current collector is a foil, mesh, or screen and the cathode active material is contacted with the current collector by casting, pressing, or rolling the mixture thereto.

The battery may also include a separator between the anode and the cathode to prevent shorting of the cell. Suitable separators include those such as, but not limited to, microporous polymer films, glass fibers, paper fibers, and ceramic materials. Illustrative microporous polymer films include, but are not limited, nylon, cellulose, nitrocellulose, polysulfone, polyacrylonitrile, polyvinylidene fluoride, polypropylene, polyethylene, polybutene, or a blend or copolymer thereof. In some embodiments, the separator is an electron beam treated micro-porous polyolefin separator. In some embodiments, the separator is a shut-down separator. Other separators may include a microporous xerogel layer. Commercially available separators include those such as, but not limited to, Celgard® 2025 and 3501, and 2325; and Tonen Setela® E25, E20, and Asahi Kasei® and Ube® separators. The separator may be provided either as a free standing film or by a direct coating application on one of the electrodes. The electrolyte and structure of the present invention may be added to the separator during cell assembly or incorporated in a coating process. Separators of a wide range of thickness may be used. For example, the separator may be from about 5 μm to about 50 μm thick. In other embodiments, the separator is from about 5 μm to about 25 μm.

In another aspect, a method of cycling any of the electrochemical devices described herein is provided. The method may include cycling the electrochemical devices at a current from about C/30 to about 1C, including any value there between (e.g., C/20, C/10, C/5, or C/2). For example, the range of currents may include about C/10 to about C/2. The method may include retaining a capacity and coulombic efficiency of at least about 80% over 200 electrochemical cycles, including at least about 90%, about 93%, and about 96%.

In another aspect, the present disclosure is directed to enhancing the stability and high-rate cycling of lithium-sulfur batteries through the incorporation of fluorinated sulfone solvents with physically confined sulfur (PYS) cathodes. While carbonyl solvents can improve electrolyte conductivity and reduce LiPS dissolution, they are vulnerable to nucleophilic attacks from LiPSs, leading to rapid capacity loss. Physically confined sulfur cathodes help mitigate this issue by restricting the interaction between the carbonyl groups and reactive LiPS species. To further address the problem, sulfone was proposed as a replacement for carbonates due to its resistance to nucleophilic attacks. However, standard sulfones like ethyl methyl sulfone (EMS) struggle to wet conventional separators made of polypropylene (PP) or polyethylene (PE), necessitating the use of glass fiber separators that significantly reduce the energy density of the cell due to a high electrolyte requirement. To overcome this limitation, fluorinated sulfones are introduced here as an alternative solvent in Li∥PYS cells. Fluorinated sulfones not only resist nucleophilic attacks from LiPSs but also exhibit improved wettability with other cell components, resulting in Li∥PYS cells with exceptional specific capacity and capacity retention.

As noted above, PYS cathodes may include material such as those with nano-confined sulfur and/or sulfurized calcined polyacrylonitrile (SPAN). Physically confined sulfur (PYS) cathodes confine the sulfur on a scaffold, thereby limiting the contact between LiPSs and the solvents having a carbonyl group. Nano-confined sulfur cathodes may be formed by melting and/or subliming sulfur and infusing it into porous carbon materials. Infusing the sulfur into the carbon may be conducted at a temperature of about 100° C. to 600° C. (e.g., 200° C. to 500° C., 300° C. to 400° C., or 350° C.) and at a pressure of about 10 mTorr to about 100 Torr. The porous carbon materials may include microporous, nanoporous, and/or ultramicroporous materials. Carbon materials may be formed by carbonizing and/or calcining polymers via thermal treatment of the polymer. Electrodes synthesized using this method may exhibit a specific capacity of about 1200 mAh/g.

Illustrative, fluorinated sulfones include both linear and cyclic materials having at least one fluorine atom on carbon atom of the sulfone. Fluorinated sulfones may be of the following formulae:

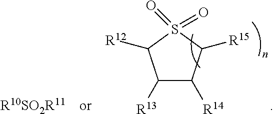

In the above formulae, R¹⁰ and R¹¹ are each individually alkyl, where at least one of R¹⁰ and R¹¹ is at least partially fluorinated; R¹², R¹³, R¹⁴, and R¹⁵ are each individually alkyl, cycloalkyl, aryl, heteroaryl, or any two may join together to form a fused ring, where at least one of R¹³, R¹⁴, R¹⁵, and R¹⁶ is at least partially fluorinated; and n is 1 or 2. In the alkyl, cycloalkyl, aryl, or heteroaryl groups, the group may also optionally include O, N, or S atoms.

Illustrative R¹⁰, R¹¹, R¹², R¹³, R¹⁴, and R¹⁵ groups include, but are not limited to, methyl, ethyl, n-propyl, n-butyl, sec-butyl, tert-butyl, n-pentyl, —CH₂OCH₃, —CH₂OCH₂CH₃, —CH₂OCH₂CH₂CH₃, —CH₂OCH₂CH₂CH₂CH₃, —CH₂CH₂OCH₃, —CH₂CH₂OCH₂CH₃, —CH₂CH₂OCH₂CH₂CH₃, —CH₂CH₂OCH₂CH₂CH₂CH₃, —CFH₂, —CF₂H, —CF₃, —CFHCH₃, —CH₂CFH₂, —CH₂CF₂H, —CH₂CF₃, —CFHCFH₂, —CFHCF₂H, —CFHCF₃, —CF₂CH₃, —CF₂CFH₂, —CF₂CF₂H, —CF₂CF₃, —CH₂CF₂CF₃, —CF(CH₃)₂, —CH₂CF₂CF₃, —CF₂CF(CF₃)₂, —CH₂CF₂CF₂H, —CH₂OCF₃, —CF₂₀CF₃, —CH₂OCF₂CF₂CF₃, —CH₂OCF₂CF₂CF₂CF₃, —CF₂OCF₂CF₂CF₃, —C₆H₅, —C₆H₄F, —C₆H₃F₂, —C₆H₂F₃, —C₆HF₄, —C₆F₅, —CH₂OC₆H₅, —CH₂OC₆H₄F, —CH₂OC₆H₃F₂, —CH₂OC₆H₂F₃, —CH₂OC₆HF₄, —CH₂OC₆F₅, —CH₂CH₂OC₆H₅, —CH₂CH₂OC₆H₄F, —CH₂CH₂OC₆H₃F₂, —CH₂CH₂OC₆H₂F₃, —CH₂CH₂OC₆HF₄, —CH₂CH₂OC₆F₅,

Illustrative fluorinated sulfones include, but are not limited to, SO₂(CH₂CF₂CF₃)₂, SO₂(CH₂CF₂CF₂H)₂, SO₂(CH₂CF₂CFH₂)₂, SO₂(CH₂CFHCF₂)₂, SO₂(CH₂CFHCF₂H)₂, SO₂(CF₂CF₂H)₂, SO₂(CF₂CFH₂)₂, SO₂(CFHCF₃)₂, SO₂(CFHCF₂H)₂, SO₂(CH₂CF₂CF₂CF₃)₂, SO₂(CH₂CF₂CF₂CF₂H)₂, SO₂(CH₂CF₂CF₂CFH₂)₂, SO₂(CH₂CFHCF₂CF₃)₂, SO₂(CH₂CFHCF₂CF₂H)₂, SO₂(CH₂CFHCF₂CFH₂)₂, SO₂(CH₂CFHCFHCF₃)₂, SO₂(CH₂CFHCFHCF₂H)₂, SO₂(CF₂CF₂CFH₂)₂, SO₂(CFHCF₂CF₃)₂, SO₂(CFHCF₂CF₂H)₂, SO₂(CFHCF₂CFH₂)₂, SO₂(CFHCFHCF₂)₂, and SO₂(CFHCFHCF₂H)₂, or a mixture of any two or more thereof.

The electrolyte may also contain a mixture of a fluorinated sulfone as described above with a carbonate, fluorinated carbonate, or a fluorinated ether. Illustrative carbonates include ethylene carbonate (EC), ethylmethylcarbonate (EMC), dimethylcarbonate (DMC), diethylcarbonate (DEC), or propylene carbonate (PC). Illustrative fluorinated carbonates include fluoroethylene carbonate (FEC), difluoroethylene carbonate (DFEC), trifluoropropylene carbonate (TFPC), fluoroethylmethyl carbonate (FEMC), and hexafluorodiethyl carbonate (HFDEC). Illustrative fluorinated ethers include 1,1,2,2-tetrafluoroethyl-2,2,2,3-tetrafluoropropyl ether (TTE), bis(2,2,2-trifluoroethyl) ether (BTFE), 1,1,2,2,-tetrafluoroethyl-2,2,2-trifluoroethyl ether (TFTFE), and methoxynonafluorobutane (MOFB), ethoxynonafluorobutane (EOFB).

The electrolyte may further include a charge carrier salt. The charge carrier salt may include a lithium salt. The lithium salt may include lithium trifluoromethanesulfonamide (LiTFSI), lithium bis(fluorosulfonyl)imide (LiFSI), lithium alkyl fluorophosphates; lithium alkyl fluoroborates; lithium 4,5-dicyano-2-(trifluoromethyl) imidazole (LiTDI); lithium 4,5-dicyano-2-methylimidazole; trilithium 2,2′,2″-tris(trifluoromethyl)benzotris (imidazolate); LiN(CN)₂; Li(CF₃CO₂); Li(C₂F₅CO₂); LiCF₃SO₃; LiCH₃SO₃; LiN(SO₂CF₃)₂ (LiTFSI); LiN(SO₂F)₂ (LiFSI); LiC(CF₃SO₂)₃; LiN(SO₂C₂F₅)₂; LiClO₄; LiBF₄; LiAsF₆; LiPF₆; LiBF₂ (C₂O₄) (LiDFOB), LiB(C₂₀₄)₂ (LiBOB); LiPF₂ (C₂O₄)₂; LiPF₄ (C₂O₄); LiAsF₆; LiN(SO₂CF₃)₂; LiN(SO₂F)₂; Li₂(B₁₂X₁₂₋ₚHₚ); Li₂(B₁₀X_{10-p′}H_{p′}); or a mixture of any two or more thereof, wherein X is independently at each occurrence a halogen, p is 0, 1, 2, 3, 4, 5, 6, 7, 8, 9, 10, 11, or 12, and p′ is 0, 1, 2, 3, 4, 5, 6, 7, 8, 9, or 10. The charge carrier salt may be present in the electrolyte at any amount including from about 0.1 M to 3 M, and any value there between. This may include a concentration from about 0.5 M to about 2 M. For example, the charge carrier salt may be 1.0 M LiFSI. In some embodiments, the electrolyte includes LiPF₆, LiFSI, LiTFSI, LiBOB, LIDFOB, LiBF₄, LiSO₃CF₃, LiClO₄, or LiTDI.

The electrolyte may further include one or more shuttle inhibitor additives. The shuttle inhibitor additives may include LiClO₄ and/or other salts with ionic N—O bonds. Illustrative shuttle inhibitors include, but are not limited to, lithium nitrate, lithium nitrite, potassium nitrate, potassium nitrite, cesium nitrate, cesium nitrite, barium nitrate, barium nitrite, ammonium nitrate, ammonium nitrite, dialkyl imidazolium nitrates, guanidine nitrate, ethyl nitrite, propyl nitrite, butyl nitrite, pentyl nitrite octyl nitrite, nitromethane, nitropropane, nitrobutanes, nitrobenzene, dinitrobenzene, nitrotoluene, dinitrotoluene, nitropyridine, dinitropyridine, pyridine N-oxide, alkylpyridine N-oxides, and tetramethyl piperidine N-oxyl (TEMPO). The concentration of the shuttle inhibitor in the electrolyte is from about 0.01 weight percent (wt. %) to about 5 wt. %. In some embodiments, the concentration of the shuttle inhibitor in the electrolyte is from about 0.1 wt. % to about 3 wt. %. In some embodiments, the concentration is from about 1.5 wt. % to about 2.5 wt. %, such as about 2.0 wt. %. The shuttle inhibitors assist in the formation of a dense protective passive film on the surface of the anode which benefits the transfer of lithium ions and plays a role in preventing the reaction between polysulfides and the lithium anode.

In addition to the fluorinated sulfones, additional solvents may be added to the electrolyte. Such other solvents may include, but are not limited to, the above hindered carbonyls, acetals, ketals, sulfones, acyclic ethers, cyclic ethers, glymes, polyethers, dioxolanes, silanes, siloxanes, ionic liquids, substituted forms of the foregoing, and blends or mixtures of any two or more such solvents. Examples of acyclic ethers that may be used include, but are not limited to, diethyl ether, dipropyl ether, dibutyl ether, dimethoxymethane, trimethoxymethane, dimethoxyethane (DME), diethoxyethane, 1,2-dimethoxypropane, and 1,3-dimethoxypropane. Examples of cyclic ethers that may be used include, but are not limited to, fluoroethylene carbonate (FEC), tetrahydrofuran (THF), tetrahydropyran, 2-methyltetrahydrofuran, 1,4-dioxane, 1,3-dioxolane (DOL), and trioxane. The cyclic ethers include non-polar fluorinated ether solvents, including, but not limited to, 1,1,2,2-tetrafluoroethyl-2,2,3,3-tetrafluoropropyl ether (TTE); 1,1,2,2-tetrafluoroethyl-2,2,3,3,3-pentafluoropropyl ether; 2,2,2-trisfluoroethyl-1,1,2,3,3,3-hexafluoropropyl ether; ethyl-1,1,2,3,3,3-hexafluoropropyl ether; difluoromethyl-2,2,3,3,3-pentafluoropropyl ether; difluoromethyl-2,2,3,3-tetrafluoropropyl ether; 2-fluoro-1,3-dioxolane; 2,2-difluoro-1,3-dioxolane; 2-trifluoromethyl-1,3-dioxolane; 2,2-bis(trifluoromethyl)-1,3-dioxolane; 4-fluoro-1,3-dioxolane; or 4,5-difluoro-1,3-dioxolane. Examples of polyethers that may be used include, but are not limited to, diethylene glylcol dimethyl ether (diglyme), triethylene glycol dimethyl ether (triglyme), tetraethylene glycol dimethyl ether (TEGDME), higher glymes, ethylene glycol divinylether, diethylene glycol divinylether, triethylene glycol divinylether, dipropylene glycol dimethylether, and butylene glycol ethers. Examples of sulfones that may be used include, but are not limited to, dimethylsulfoxide, sulfolane, 3-methyl sulfolane, and 3-sulfolene. Other electrolyte solvents that may be used include, but are not limited to, oligo (ethylene glycol)-substituted siloxanes, oligo (ethylene glycol)-substituted silanes, and ionic liquids. Ratios of highly hindered carbonyl solvents to other solvents in the electrolyte may be about 1:10 to about 10:1 (e.g., 1:5, 1:2, 1:1, 2:1, or 5:1). For example, the additional solvent may include a cyclic ether, which may include fluoroethylene carbonate (FEC), 1,1,2,2-tetrafluoroethyl-2,2,3,3-tetrafluoropropyl ether (TTE), or a combination thereof. For example, the ratio of highly hindered carbonyl solvents to additional solvent may be 1:1.

The cathode of the Li—S battery is a sulfur-based electrode that includes sulfur and may also include metal sulfide and/or conductive carbon. The sulfur may be elemental and provided as such. The sulfur may be combined with active metal sulfide materials. The metal sulfide materials may include Mo₆S₈. Examples of conductive carbons include synthetic graphite, natural graphite, amorphous carbon, hard carbon, soft carbon, acetylene black, mesocarbon microbeads (MCMB), carbon black, Ketjen® black, carbon Super P, mesoporous carbon, porous carbon matrix, carbon nanotube, carbon nanofiber, graphene, ultramicroporous carbon, and mixtures of two or more thereof. The conductive carbon is preferably porous allowing for sequestration or entrapment of the sulfur within the conductive carbon, thereby rendering the sulfur confined to the cathode.

The cathode may be prepared by mixing sulfur with a conductive carbon material and a binding agent in the presence of a solvent to form a slurry. Illustrative binders include, but are not limited to, gelatine, polytetrafluoroethylene (PTFE), polyvinylidene fluoride (PVDF), polyethylenetetrafluoroethylene (ETFE), polyvinyl alcohol (PVA), polyethylene, polystyrene, polyethylene oxide, polyacrylonitrile, polyimide, polyamide, styrene butadiene rubber (SBR), carboxy methyl cellulose (CMC), alginate, gelatin, a copolymer of any two or more such polymers, or a blend of any two or more such polymers. The solvent may be N-methylpyrrolidone, acetone, water, or the like. The cathode may be prepared by coating and drying the mixture of the sulfur, carbon material, and binding agent directly on a current collector, or by casting the mixture on a separate support to form a film and then laminating the film on a current collector.

Illustrative anode materials include metallic lithium and carbon materials including, but not limited to, synthetic graphite, natural graphite, amorphous carbon, hard carbon, soft carbon, mesocarbon microbeads (MCMB), or a combination thereof. The anode active material may be a metallic lithium foil alone, metallic lithium mixed with an active carbon material, or metallic lithium intercalated within an active carbon material, where the active carbon material may be, but is not limited to, synthetic graphite, natural graphite, amorphous carbon, hard carbon, soft carbon, mesocarbon microbeads (MCMB).

According to some embodiments, the current collector may include copper, stainless steel, titanium, tantalum, platinum, gold, aluminum, nickel, cobalt nickel alloy, highly alloyed ferritic stainless steel containing molybdenum and chromium; or nickel-, chromium-, molybdenum-containing alloys, and carbon-coated versions of any one or more thereof. The current collector is a foil, mesh, or screen and the cathode active material is contacted with the current collector by casting, pressing, or rolling the mixture thereto.

The battery may also include a separator between the anode and the cathode to prevent shorting of the cell. Suitable separators include those such as, but not limited to, microporous polymer films, glass fibers, paper fibers, and ceramic materials. Illustrative microporous polymer films include, but are not limited, nylon, cellulose, nitrocellulose, polysulfone, polyacrylonitrile, polyvinylidene fluoride, polypropylene, polyethylene, polybutene, or a blend or copolymer thereof. In some embodiments, the separator is an electron beam treated micro-porous polyolefin separator. In some embodiments, the separator is a shut-down separator. Other separators may include a microporous xerogel layer. Commercially available separators include those such as, but not limited to, Celgard® 2025 and 3501, and 2325; and Tonen Setela® E25, E20, and Asahi Kasei® and Ube® separators. The separator may be provided either as a free standing film or by a direct coating application on one of the electrodes. The electrolyte and structure of the present invention may be added to the separator during cell assembly or incorporated in a coating process. Separators of a wide range of thickness may be used. For example, the separator may be from about 5 μm to about 50 μm thick. In other embodiments, the separator is from about 5 μm to about 25 μm.

The present invention, thus generally described, will be understood more readily by reference to the following examples, which are provided by way of illustration and are not intended to be limiting of the present invention.

### Examples

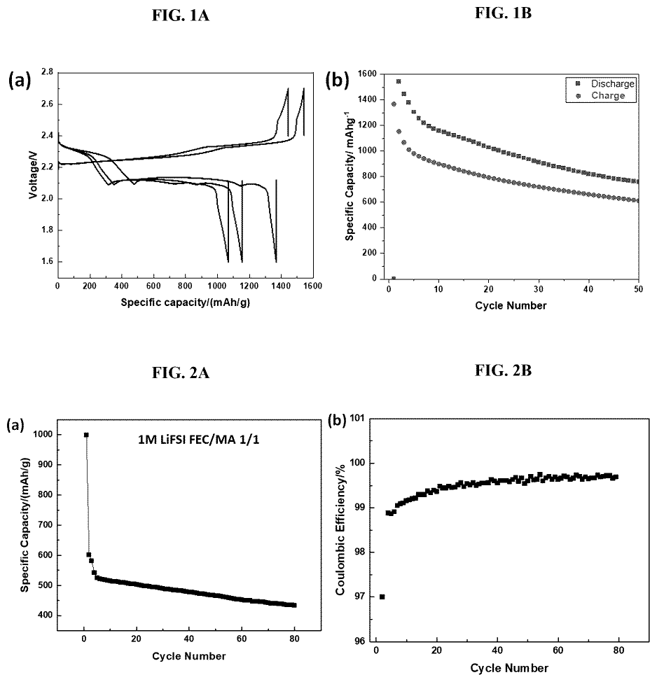

Example 1. Hindered Solvents. Lithium bis(trifluoromethylsulfonyl)imide (LiTFSI; 1M) was dissolved in a 1:1 (vol:vol) mixture of dimethoxyethane (DME) and 1,3-dioxolane (DOL) as a baseline (i.e. comparative) ethereal electrolyte. FIGS. 1A and 1B depict voltage profiles and cycling performance of Li∥SPAN cells made with the electrolyte. As illustrated, the cells exhibited significant capacity fading in the cells with the ethereal electrolyte, as well as a comparatively worse Coulomibc efficiency (CE) of the cell. The CEs were only at around 80% for the first 20 cycles, which we believe is due to shuttling of the LiPSs.

The SPAN in the Li∥SPAN cells in Example 1 were prepared by mixing sublimed sulfur and polyacrylonitrile (PAN) in a weight ratio of 4:1 and calcining the mixture at 350° C. for 9 hours in a tubular furnace under a nitrogen atmosphere, producing SPAN powder. The resulting SPAN powder is mixed with polyvinylidene fluoride (PVDF) binder and carbon black in a weight ratio of 8:1:1 until well-blended and formed into a slurry in a solvent. The well-blended slurry was cast onto carbon-coated aluminum foil and dried at 60° C. for 12 hours in a vacuum oven to form the SPAN electrode.

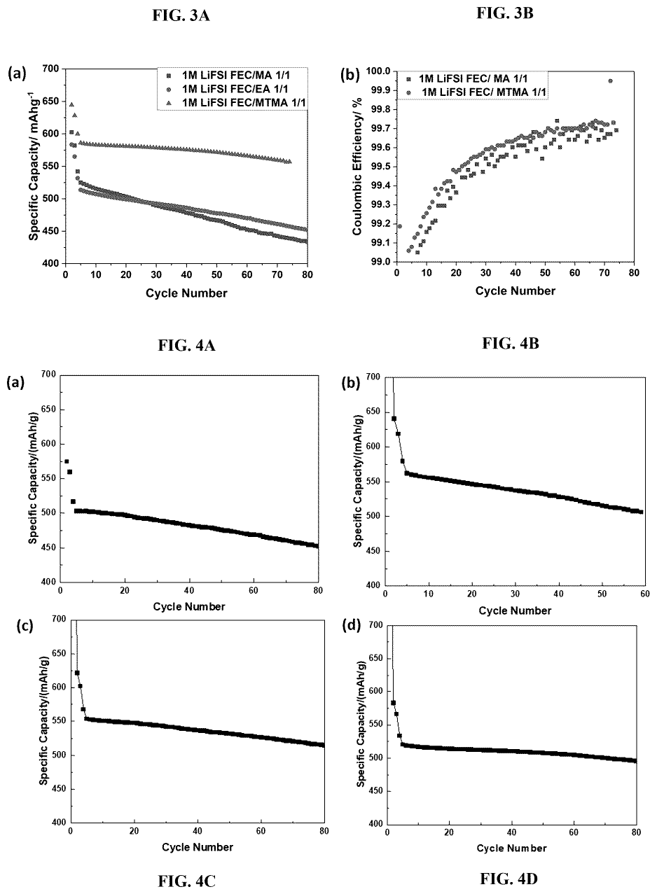

However in Li∥SPAN cells prepared using fluoroethylene carbonate (FEC) and methyl acetate (“MA”) showed significantly improved capacity retention and CE (FIGS. 2A and 2B). However, the MA cells exhibited relatively low Coulombic efficiency (CE) and capacity retention compared to the cells employing a 1M LiFSI FEC/MTMA electrolyte (FIGS. 3A and 3B). It is believed that side reactions occur between the SPAN cathode and MA/EA (ethyl acetate) due to the susceptibility of the carbonyl group in MA/EA to nucleophilic attack by lithium polysulfides or other sulfide anions generated during the charging of the SPAN cathode. This issue was even more significant when EA was replaced by methyl acetate (“MA”), which is even more susceptible to nucleophilic attack due to reduced steric hindrance. To address these side reactions, the highly sterically hindered solvent MTMA was used instead. The use of MTMA in the Li∥SPAN cell led to stable cycling with high CE. This result clearly demonstrates the significant benefit of using a sterically hindered solvent to block the side reactions between sulfide by-products and carbonyl solvents.

The beneficial effects of highly sterically hindered carbonyl solvents were further confirmed by comparing the cycling performance of Li∥SPAN cells using different γ-lactone solvents with varying susceptibility to nucleophilic attack. In the case of GBL and GVL, the absence of a α-methyl group adjacent to the carbonyl carbon made the carbonyl group susceptible to nucleophilic attack. Consequently, Li∥SPAN cells using GBL and GVL-containing electrolytes exhibited relatively unstable cycling. In contrast, cells using MBL and DMBL-based electrolytes demonstrated significantly more stable cycling performance (FIGS. 4A-4D). This enhanced stability is attributed to the presence of an α-methyl group or α-dimethyl group, which greatly reduces the likelihood of nucleophilic attack on the γ-lactone by enhancing steric hindrance.

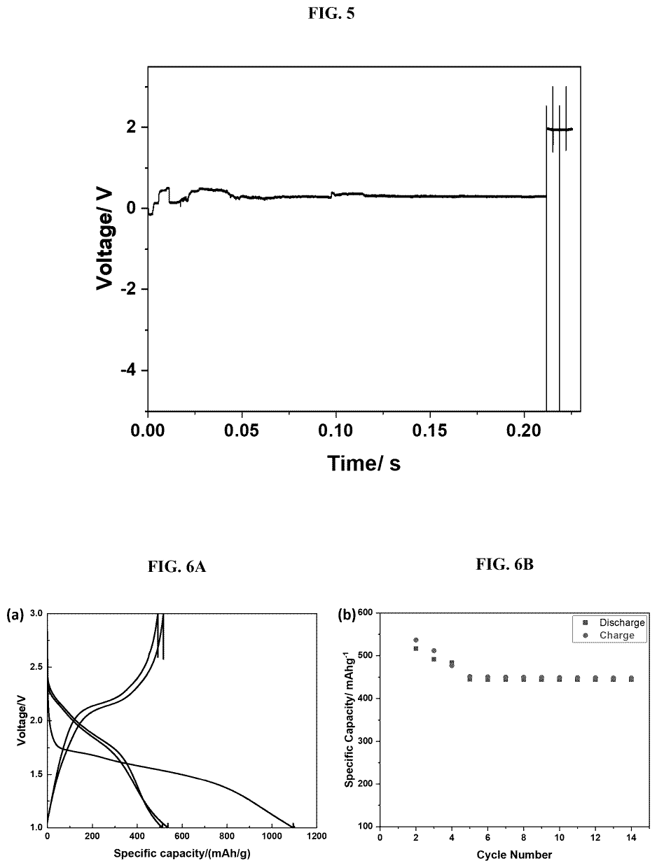

Example 2. Sulfones. Due to their resistance to nucleophilic attack, sulfone molecules show promise as a solvent for Li—S batteries. However, regular (i.e. non-fluorinated) sulfones are known for their poor wettability with other cell components. As shown in FIG. 5, the voltage profile of a Li∥SPAN cell using a 1M LiFSI FEC/EMS (EMS is ethylmethyl sulfone) electrolyte and a conventional polypropylene-polyethylene (PP-PE) separator indicates that the electrolyte fails to properly wet the separator, resulting in the cell's malfunction.

In cells prepared with a glass fiber separator and using a larger amount of electrolyte (~100 μL), a Li∥SPAN cell was cycled with a specific capacity of about 450 mAh g⁻¹, as shown in FIGS. 6A and 6B. However, the specific capacity remained relatively low, and the use of a large volume of electrolyte significantly reduces the cell's energy density, making the use of regular sulfone impractical.

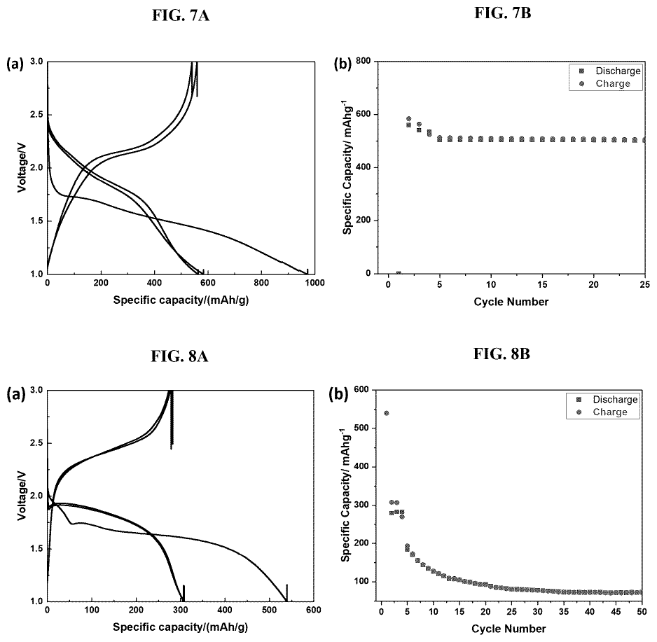

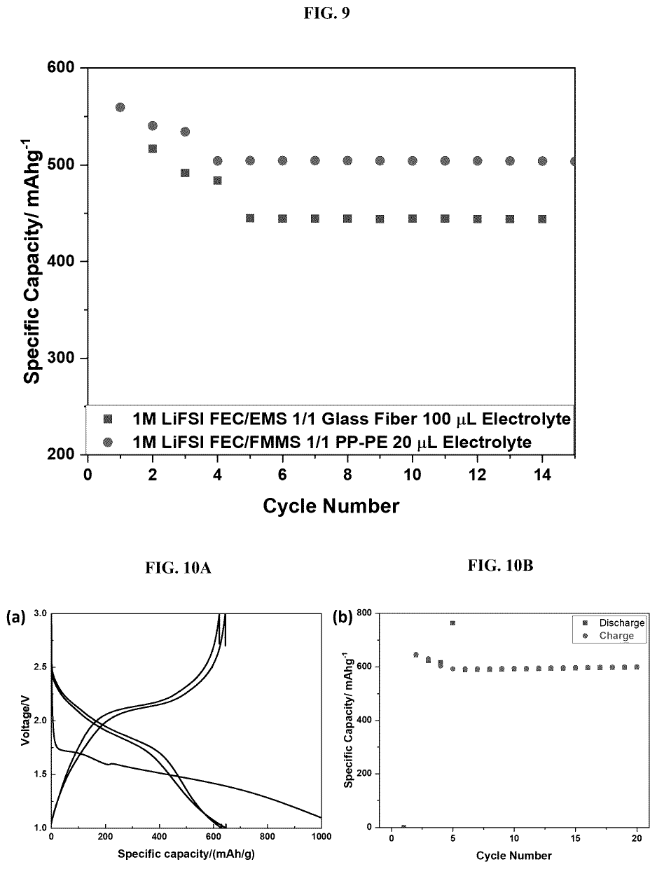

In cells prepared with a fluorinated sulfone, the cells exhibit not only improved wettability with other cell components but also enables better cycling performance. FIGS. 7A and 7B show the voltage profiles and cycling performance, respectively, of a Li∥SPAN cell using a 1M LiFSI in FEC/FMMS (trifluoromethylmethylsulfone) electrolyte. It is evident that the use of FMMS results in higher specific capacity and Coulombic efficiency for the sulfur cell. However, this improvement is limited to the physically confined sulfur cathode. When a conventional carbon-sulfur composite cathode is used with the FEC/FMMS electrolyte, the specific capacity is very low, and there is extremely rapid capacity fading, as depicted in FIGS. 8A and 8B. Even with just 20 μL of FMMS-based electrolyte (only 20% of the 100 μL of EMS-based electrolyte), the Li∥SPAN cell using FEC/FMMS exhibited significantly better cycling performance compared to the cell with FEC/EMS electrolyte. See FIG. 9. This clearly demonstrates the advantages of using fluorinated sulfone with a physically confined sulfur cathode.

Finally, the cycling performance of a Li∥SPAN cell can be further enhanced by using a LiFSI in FMMS electrolyte in a 1:4 molar ratio. As shown in FIGS. 10A and 10B, the cell achieved an exceptionally high specific capacity of 600 mAhg⁻¹, along with stable cycling and good capacity retention.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, 18nclude the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrochemical cell comprising:
a cathode comprising surface-confined sulfur;
an anode comprising lithium metal; and
an electrolyte comprising:
a sterically hindered carbonyl solvent; and
a lithium salt.

2. The electrochemical cell of claim 1, wherein the sterically hindered carbonyl solvent comprises 3-methyldihydrofuran-2 (3H)-one), 3,3-dimethyldihydrofuran-2 (3H)-one, or methyl trimethylacetate.

3. The electrochemical cell of claim 1, wherein the surface confined sulfur comprises a nano-confined sulfur.

4. The electrochemical cell of claim 1, wherein the surface confined sulfur comprises a sulfurized calcined polyacrylonitrile.

5. The electrochemical cell of claim 1, wherein the cathode further comprises ultramicroporous carbon within which is trapped the surface confined sulfur and wherein the ultramicroporous carbon is sequestered at the cathode.

6. The electrochemical cell of claim 1, wherein the cathode further comprises a binder.

7. The electrochemical cell of claim 1, wherein the lithium salt comprises trifluoromethanesulfonamide (LiTFSI), lithium bis(fluorosulfonyl)imide (LiFSI), a lithium alkyl fluorophosphate, a lithium alkyl fluoroborate, a lithium 4,5-dicyano-2-(trifluoromethyl) imidazole, lithium 4,5-dicyano-2-methylimidazole, trilithium 2,2′,2″-tris(trifluoromethyl)benzotris (imidazolate), LiN(CN)₂, Li(CF₃CO₂), Li(C₂F₅CO₂), LiCF₃SO₃, LiCH₃SO₃, LiN(SO₂CF₃)₂, LiN(SO₂F)₂, LiC(CF₃SO₂)₃, LiN(SO₂C₂F₅)₂, LiClO₄, LiBF₄, LiAsF₆, LiPF₆, LiBF₂ (C₂O₄), LiB(C₂₀₄)₂, LiPF₂ (C₂O₄)₂, LiPF₄ (C₂O₄), LiAsF₆, LiN(SO₂CF₃)₂, LiN(SO₂F)₂, or a combination of any two or more thereof.

8. The electrochemical cell of claim 1, wherein the electrolyte further comprises an additional solvent.

9. The electrochemical cell of claim 8, wherein a ratio of sterically hindered carbonyl solvent to additional solvent is about 2:1 to about 1:2.

10. An electrolyte for a lithium-sulfur electrochemical cell comprising:
a sterically hindered carbonyl solvent; and
a lithium salt.

11. An electrochemical cell comprising:
a cathode comprising surface-confined sulfur;
an anode comprising lithium metal; and
an electrolyte comprising:
a fluorinated sulfone; and
a lithium salt.

12. The electrochemical cell of claim 11, wherein the fluorinated sulfone is a compound of formula: 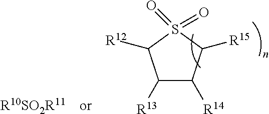
wherein:
R¹⁰ and R¹¹ are each individually alkyl, where at least one of R¹⁰ and R¹¹ is at least partially fluorinated;
R¹², R¹³, R¹⁴, and R¹⁵ are each individually alkyl, cycloalkyl, aryl, heteroaryl, or any two may join together to form a fused ring, where at least one of R¹³, R¹⁴, R¹⁵, and R¹⁶ is at least partially fluorinated; and
n is 1 or 2; and
wherein any alkyl, cycloalkyl, aryl, or heteroaryl group optionally includes O, N, or S atoms.

13. The electrochemical cell of claim 12, wherein R¹⁰, R¹¹, R¹², R¹³, R¹⁴, and R¹⁵ are each individually selected from the group consisting of: methyl, ethyl, n-propyl, n-butyl, sec-butyl, tert-butyl, n-pentyl, —CH₂OCH₃, —CH₂OCH₂CH₃, —CH₂OCH₂CH₂CH₃, —CH₂OCH₂CH₂CH₂CH₃, —CH₂CH₂OCH₃, —CH₂CH₂OCH₂CH₃, —CH₂CH₂OCH₂CH₂CH₃, —CH₂CH₂OCH₂CH₂CH₂CH₃, —CFH₂, —CF₂H, —CF₃, —CFHCH₃, —CH₂CFH₂, —CH₂CF₂H, —CH₂CF₃, —CFHCFH₂, —CFHCF₂H, —CFHCF₃, —CF₂CH₃, —CF₂CFH₂, —CF₂CF₂H, —CF₂CF₃, —CH₂CF₂CF₃, —CF(CH₃)₂, —CH₂CF₂CF₃, —CF₂CF(CF₃)₂, —CH₂CF₂CF₂H, —CH₂OCF₃, —CF₂OCF₃, —CH₂OCF₂CF₂CF₃, —CH₂OCF₂CF₂CF₂CF₃, —CF₂OCF₂CF₂CF₃, —C₆H₅, —C₆H₄F, —C₆H₃F₂, —C₆H₂F₃, —C₆HF₄, —C₆F₅, —CH₂OC₆H₅, —CH₂OCH₄F, —CH₂OC₆H₃F₂, —CH₂OC₆H₂F₃, —CH₂OC₆HF₄, —CH₂OC₆F₅, —CH₂CH₂OC₆H₅, —CH₂CH₂OC₆H₄F, —CH₂CH₂OC₆H₃F₂, —CH₂CH₂OC₆H₂F₃, —CH₂CH₂OCHF₄, and —CH₂CH₂OC₆F₅.

14. The electrochemical cell of claim 11, wherein the fluorinated sulfone comprises: SO₂(CH₂CF₂CF₃)₂, SO₂(CH₂CF₂CF₂H)₂, SO₂(CH₂CF₂CFH₂)₂, SO₂(CH₂CFHCF₂)₂, SO₂(CH₂CFHCF₂H)₂, SO₂(CF₂CF₂H)₂, SO₂(CF₂CFH₂)₂, SO₂(CFHCF₃)₂, SO₂(CFHCF₂H)₂, SO₂(CH₂CF₂CF₂CF₃)₂, SO₂(CH₂CF₂CF₂CF₂H)₂, SO₂(CH₂CF₂CF₂CFH₂)₂, SO₂(CH₂CFHCF₂CF₃)₂, SO₂(CH₂CFHCF₂CF₂H)₂, SO₂(CH₂CFHCF₂CFH₂)₂, SO₂(CH₂CFHCFHCF₃)₂, SO₂(CH₂CFHCFHCF₂H)₂, SO₂(CF₂CF₂CFH₂)₂, SO₂(CFHCF₂CF₃)₂, SO₂(CFHCF₂CF₂H)₂, SO₂(CFHCF₂CFH₂)₂, SO₂(CFHCFHCF₂)₂, or SO₂(CFHCFHCF₂H)₂.

15. The electrochemical cell of claim 11, wherein the electrolyte further comprises a fluorinated carbonate or a fluorinated ether.

16. The electrochemical cell of claim 11, wherein the surface confined sulfur comprises a nano-confined sulfur.

17. The electrochemical cell of claim 11, wherein the surface confined sulfur comprises a sulfurized calcined polyacrylonitrile.

18. The electrochemical cell of claim 11, wherein the cathode further comprises ultramicroporous carbon within which is trapped the surface confined sulfur and wherein the ultramicroporous carbon is sequestered at the cathode.

19. The electrochemical cell of claim 11, wherein the cathode further comprises a binder.

20. The electrochemical cell of claim 11, wherein the lithium salt comprises trifluoromethanesulfonamide (LiTFSI), lithium bis(fluorosulfonyl)imide (LiFSI), a lithium alkyl fluorophosphate, a lithium alkyl fluoroborate, a lithium 4,5-dicyano-2-(trifluoromethyl) imidazole, lithium 4,5-dicyano-2-methylimidazole, trilithium 2,2′,2″-tris(trifluoromethyl)benzotris (imidazolate), LiN(CN)₂, Li(CF₃CO₂), Li(C₂F₅CO₂), LiCF₃SO₃, LiCH₃SO₃, LiN(SO₂CF₃)₂, LiN(SO₂F)₂, LiC(CF₃SO₂)₃, LiN(SO₂C₂F₅)₂, LiClO₄, LiBF₄, LiAsF₆, LiPF₆, LiBF₂(C₂O₄), LiB(C₂O₄)₂, LiPF₂ (C₂O₄)₂, LiPF₄ (C₂O₄), LiAsF₆, LiN(SO₂CF₃)₂, LiN(SO₂F)₂, or a combination of any two or more thereof.
